(19) United States
(12) Patent Application Publication
(10) Pub. No.: US 2007/0019932 A1
(43) Pub. Date: Jan. 25, 2007

(54) Digital photo album producing apparatus

(75) Inventors: Chao King, Fremont, CA (US); John R. Christ, Santa Clara, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA TECHNOLOGY U.S.A., INC.

(21) Appl. No.: 11/183,760

(22) Filed: Jul. 19, 2005

(51) Int. Cl. H04N 5/00

(52) U.S. Cl. 386/121

(57) ABSTRACT

The present application relates to a digital photo album producing apparatus which can produce the digital photo album file so that a player for a removable optical storage medium can decode and display the digital photo album file, and the index file so that the index file comprises still thumbnail image data and pointer which is a command to jump to a certain chapter or segment of digital photo album file including still image or movie corresponding to the thumbnail image.

### FIELD

The present invention relates to a digital photo album producing apparatus.

### INTRODUCTION

As digital cameras spread in the world, we can obtain digital photos easily. In addition, we can see the digital photos on our personal computer easily.

Recently, it is desirable that a digital photo album including digital photos can be seen on a normal television by playback of the digital photo by a normal DVD player and the like. Furthermore, because a lot of photos can be stored in one recording medium, it is desirable to retrieve the photo which the user wants to see easily and quickly.

### SUMMARY

According to various embodiments, the present teachings can provide a digital photo album producing apparatus. The digital photo album producing apparatus can comprise a reading section which can read image data including at least one of still image data and movie data comprising audio data. The digital photo album producing apparatus can comprise an image data storing section which stores image data read by the reading section. The digital photo album producing apparatus can comprise a processing section which produces a digital photo album file and an index file based on the image data stored in the image data storing section. The digital photo album producing apparatus can comprise a recoding section which records the digital photo album file and the index file produced by the processing section onto a removable optical storage medium. The digital photo album file can be a serial of still image file and the index file can comprise still thumbnail image data. The processing section can produce the digital photo album file by compressing and mixing the still image data and the movie data comprising the audio data into one file so that a player for the removable optical storage medium can decode and display the digital photo album file. The processing section can produce the index file so that each of the still thumbnail image data is linked with certain part of the digital photo album file.

### BRIEF DESCRIPTION OF THE DRAWINGS

FIG. 1 illustrates a figure for explanation of image data, according to certain embodiments.

FIG. 2 illustrates a figure for explanation of image data, according to certain embodiments.

FIG. 3 illustrates a figure for explanation of image data, according to certain embodiments.

FIG. 4 illustrates a figure for explanation of calculation of playback time of a digital photo album file, according to certain embodiments.

FIG. 5 illustrates a figure for explanation of a digital photo album file, according to certain embodiments.

FIG. 6 illustrates a figure for explanation of a digital photo album file, according to certain embodiments.

FIG. 7 illustrates a perspective view of a digital photo album producing apparatus, according to certain embodiments.

FIG. 8 illustrates a block diagram of a digital photo album producing apparatus, according to certain embodiments.

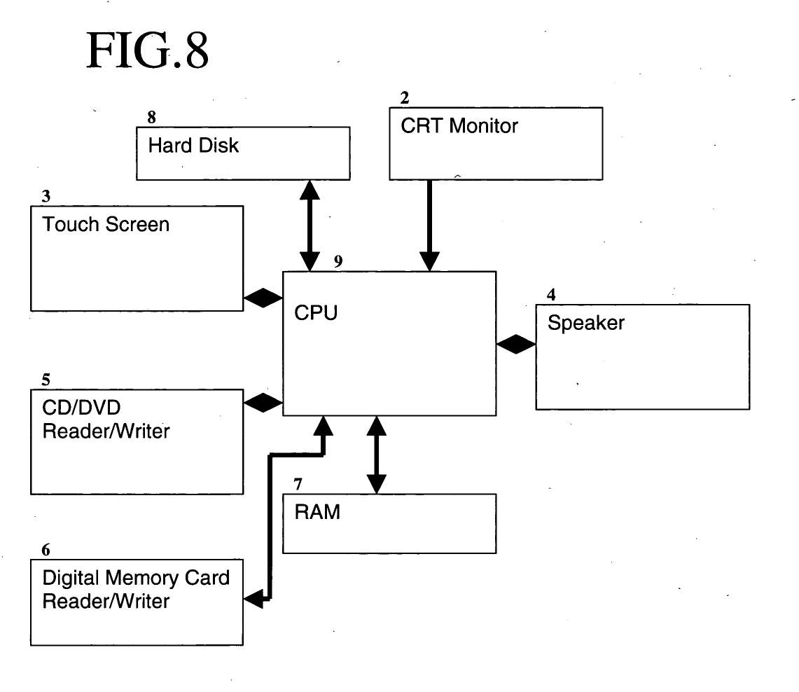

FIG. 9 illustrates a graphic display of a digital photo album producing apparatus, according to certain embodiments.

FIG. 10 illustrates a graphic display of a digital photo album producing apparatus, according to certain embodiments.

FIG. 11 illustrates a graphic display of a digital photo album producing apparatus, according to certain embodiments.

FIG. 12 (a) and (b) illustrates a graphic display of a TV displaying the digital photo album, according to certain embodiments.

FIG. 13 illustrates a graphic display of a TV displaying the index, according to certain embodiments.

### DESCRIPTION OF CERTAIN EMBODIMENTS

Apparatus

In certain embodiments, a digital photo album producing apparatus can comprise at least one of a reading section, an image data storing section, a recording section and a processing section. In certain embodiments, the digital photo album producing apparatus can comprise a data storing section, an input section, a sound output section, a display section and a verification section.

In certain embodiments, a digital photo album producing apparatus can comprise a personal computer.

In certain embodiments, the reading section can read and obtain image data. In certain embodiments, the reading section can obtain image data by reading the image data recording medium storing image data. In certain embodiments, the reading section can obtain image data by receiving image data via network.

In certain embodiments, the image data recording medium (in other words, the removable data recording medium) can store the image data taken by a digital still camera, a digital video camera and so on. Examples of the image data recording medium consistent with certain embodiments of the invention include, but are not limited to, a digital memory card, a compact disk (CD) (e.g., CD-R, CD-RW, etc), and a digital versatile disk (DVD) (e.g., DVD-R, DVD-RW, DVD+RW, etc.). Various types of digital memory cards compatible with certain embodiments of the invention include, but are not limited to, secure digital (SD) memory card, Compact Flash™, Smart Media™, Memory Stick™, and the like.

In certain embodiments, the image data can comprise still image data and/or movie data. In certain embodiments, the image data can comprise only still image data. In certain embodiments, the image data can comprise only the movie data. In certain embodiments, the movie data can comprise audio data including voice of people and/or sound of surrounding. In certain embodiments, the movie data can comprise data of the playback time of the movie data. In certain embodiments, each of the still image data and the movie data can be stored in different files respectively in the image data recording medium. In certain embodiments, the format of the still image data stored in the image data recording medium can be JPEG format, and so on. In certain embodiments, the format of the movie data including the audio data stored in the image data recording medium can be AVI format, MOV format and so on. In certain embodiments, the image data stored in the image data recording medium can be included in a standard image related file. Example of the standard image related file consistent with embodiments of the invention include, but are not limited to, a file under DCIM directory, AVI file, MOV file and JPG file.

In certain embodiments, the reading section might not read all data included in the image data recording medium. In certain embodiments, the reading section can read only the standard image related file from the various files or data recorded in the image data recording medium. Examples of the reading section consistent with certain embodiments of the invention include, but are not limited to, a CD reader, a CD reader/writer, a DVD reader, a DVD reader/writer, a digital memory card reader, a digital memory card reader/writer, a local area network (LAN) adapter, a modem and a network card. In certain embodiments, the reading section can be means for reading the image data (in other word, reading means).

In certain embodiments, the image data storing section can store image data read and obtained by the reading section. In certain embodiments, the image data storing section can store the image data temporarily and can delete the image data when the producing of a digital photo album file based on the image data stored in the image data storing section is completed. In certain embodiments, the image data storing section can store the image data whose format (e.g., JPEG, AVI, MOV, and so on) is same with the original image data stored in the image data recording medium. Examples of the image data storing section consistent with certain embodiments of the invention include, but are not limited to, a memory such as a non volatile memory (e.g., a non volatile random access memory (NVRAM), M RAM, P RAM, Fe RAM, Flash RAM and the like) and a hard disk.

In certain embodiments, the recording section can record the digital photo album file comprising several chapters and the index file produced by the processing section onto a removable optical storage medium. In certain embodiments, the recording section can record the digital photo album file produced by the processing section onto the removable optical storage medium according to video image related format (e.g., video CD format, DVD format (including DVD-video specification, DVD-R specification, DVD+R specification, DVD-RW specification and DVD+RW specification)). For instance, the recording section can record the digital photo album file onto the DVD according to DVD video specification. In certain embodiments, the recording section can record the original image data (in other words, raw data), which is originally stored in the image data recording medium or received via network, into the removable optical storage medium in addition to the digital photo album file produced by the processing section.

Examples of the removable optical storage medium consistent with certain embodiments of the invention include, but are not limited to, a digital memory card, a CD (e.g., CD-R, CD-RW etc.), and a DVD (e.g., DVD-R, DVD-RW, DVD+RW, etc.). Various types of digital memory cards compatible with certain embodiments of the invention include, but are not limited to, SD memory card, Compact Flash™, Smart Media™, Memory Stick™, and the like. Examples of the recording section consistent with certain embodiments of the invention include, but are not limited to, a CD writer, a CD reader/writer, a DVD writer, a DVD reader/writer, a digital memory card writer and a digital memory card reader/writer. In certain embodiments, the recording section can be means for recording the digital image album file onto the removable optical storage medium (in other words, recording means).

In certain embodiments, the data storing section can store at least one of background music data. In certain embodiments, the format of the background music data stored in the data storing section can be WAVE format and so on. In certain embodiments, the background music data can comprise reference information of each of the background music (e.g., a title, a reference number, an artist and so on), playback time of each of the background music data and so on in addition to the background music itself. In certain embodiments, each background music data can be stored in the data storing section in the form of a background music file. In certain embodiments, the data storing section can store minimum time data and maximum time data for playback time of each still image. In certain embodiments, the data storing section can store the authorized data for the verification of the removable optical storage medium. In certain embodiments, the data storing section can store format data for calculation. Examples of the data storing section consistent with certain embodiments of the invention include, but are not limited to, a memory such as a non volatile memory (e.g., a non volatile random access memory (NVRAM), M RAM, P RAM, Fe RAM, Flash RAM and the like) and a hard disk. In certain embodiments, the image data storing section and the data storing section can be one same component. In certain embodiments, the image data storing section and the data storing section can be different components. In certain embodiments, the image data storing section and/or the data storing section can be means for storing the image data, the background music data and/or other various data (in other words, storing means).

In certain embodiments, the user can input operation, number, letter, data or instruction to the digital photo album producing apparatus from the input section. In certain embodiments, the user can designate orientation of the image data, order of displaying of the image data or the resolution of the image data by the input section. In certain embodiments, the user can input a reference information (e.g., a title, a place of taking photo, a name of person and the like) of the digital photo album file by the input section. Examples of the input section consistent with certain embodiments of the invention include, but are not limited to, a keyboard, a mouse, a push button and a touch screen. In certain embodiments, the input section can be means for inputting background music selection and/or various instruction, data (in other words, inputting means).

In certain embodiments, an user can select background music based on the background music data stored in the data storing section by utilizing the input section. In certain embodiments, the user can select no background music by utilizing input section. In certain embodiments, the user can select the still image data and/or the movie data which the user wants to include in the digital photo album file by utilizing the input section.

In certain embodiments, the sound output section can output background music based on the background music data, the voice of people and/or the sound of surrounding based on the audio data of the movie data and various sounds. In certain embodiments, the user can confirm the background music by playing the background music data from the sound output section before the user decides the background music data by the input section. Examples of the sound output section consistent with certain embodiments of the invention include, but are not limited to, a speaker. In certain embodiments, the sound output section can be means for outputting background music data, audio data and/or the various sound (in other words, sound outputting means).

In certain embodiments, the display section can display still image based on the still image data of the image data, movie based on the movie data of the image data and various instructions, messages and/or images. Examples of the display section consistent with certain embodiments of the invention include, but are not limited to, a liquid crystal display (LCD), a Braun tube, a cathode ray tube (CRT) and a plasma display panel. In certain embodiments, the input section can be combined with the display section as one component (e.g., the touch panel on the display). In certain embodiments, the display section can be means for displaying image data and/or various image (in other words, displaying means).

In certain embodiments, the verification section can verify whether the removable optical storage medium to be used for recording the digital photo album file is an authorized medium or not. In certain embodiments, only if the verification section judges that the removable optical storage medium is the authorized medium, the verification section can allow the recording section to record the digital photo album file produced by the producing section onto the verified removable optical storage medium. In certain embodiments, if the verification section judges that the removable optical storage medium is not the authorized medium, the verification section can prohibit the recording section from recording the digital photo album file. In certain embodiments, the removable optical storage medium which records correct authorized data (e.g., an authorized seal, an authorized signal, an authorized code, a manufacture code, a password, an ID and the like) can be regarded as the authorized medium. In certain embodiments, the removable optical storage medium in which the correct authorized data is stamped beforehand can be regarded as the authorized medium. For instance, in the case that the manufacture code is used as the authorized data, same manufacture code can be stamped on all of the removable optical storage medium which are manufactured by the same manufacturer. In certain embodiments, the correct authorized data can be stored in the data storing section beforehand, then the verification section can compare the authorized data recorded or stamped in the removable optical storage medium which is inserted into the digital photo album producing apparatus with the authorized data stored in the data storing section or can confirm whether the same data with the authorized data stored in the data storing section is recorded or stamped in the removable optical storage medium. In certain embodiments, only if the verification section judges that the authorized data recorded or stamped in the removable optical storage medium is consistent with the authorized data stored in the data storing section or finds the same data with the authorized data stored in the data storing section from the removable optical storage medium, the verification section can regard such removable optical storage medium as the authorized medium. Examples of the verification section consistent with certain embodiments of the invention include, but are not limited to, a central processing unit (CPU) or a micro processing unit (MPU), with a memory and software for verification, if necessary. In certain embodiments, the verification section can be means for verifying whether the removable optical storage medium is authorized or not (in other words, verifying means).

In certain embodiments, the processing section can produce a digital photo album file and an index file based on the image data stored in the image data storing section.

In certain embodiments, the digital photo album file can be a serial of still image file. When the digital photo album file is reproduced, each still image data and movie data in the digital photo album file can be decoded and displayed sequentially. In certain embodiments, the digital photo album file can comprise several chapters. In certain embodiments, each of the chapter can be consist of only still image data or only movie data. One chapter is not consist of both of still image data and movie data. In certain embodiments, the maximum number of still images which can be included in one chapter can be limited. For instance, one chapter can include 20 still images at most.

In certain embodiments, the index file can comprise still thumbnail image data. In certain embodiments, the index file can comprise several pages in each of which the still thumbnail image data is included. In certain embodiments, each still thumbnail image data can represent each of the still image data and the movie data included in the digital photo album file. In certain embodiments, each of still thumbnail image data can be linked with certain chapter of the digital photo album file theoretically. In certain embodiments, each of still thumbnail image data can be linked with certain chapter which includes the still image or the movie corresponding to the thumbnail theoretically. In certain embodiments, the index file can comprise a pointer to certain part of digital photo album file. In certain embodiments, each of still thumbnail image data can comprise the pointer to jump to the chapter or the segment including the still image or the movie corresponding to the thumbnail. For instance, the pointer can be a command to jump to designated chapter or segment .

In certain embodiments, the processing section can produce the digital photo album file by compressing and mixing the still image data and the movie data comprising the audio data into one file so that a player for the removable optical storage medium can decode the digital photo album file. In this specification, the player for the removable optical storage medium is a standard stand-alone player for the removable optical storage medium which can connect to a TV or other display apparatus to playback the recorded still image or movie image, but the player cannot copy the still image or the movie image. stored on the removable optical storage medium onto another removable optical storage medium.

For instance, in the case the removable optical storage medium is a DVD, the processing section can produce the digital photo album file according to the DVD video specification so that a DVD player can decode the digital photo album file for the display on the TV or other display apparatus. The DVD video specification is the “DVD Specifications for Read-Only Disc/Part 3: Video Specifications Version 1.1, 3Mar. 2002.” The DVD player is a standard stand-alone DVD player which can connect to a TV or other display device to playback the stamped DVD-video or the recorded DVD-R or DVD-RW with DVD-video specification.

In certain embodiments, the DVD recording drive or the DVD read-only drive connected to the PC can also play the digital photo album file recorded on the DVD, but the DVD recording drive cannot create an exact copy of the DVD. In certain embodiments, the processing section can produce the digital photo album according to the DVD video specification and DVD-R specification so that the DVD player, the DVD recording drive and the DVD read-only drive can decode the digital photo album file for the display on the TV or other display apparatus

In certain embodiments, the processing section can produce the index file as follows. The processing section can take a template file with the layout of button count of thumbnail, placement and size for each menu page. The processing section can resize the individual still image data to fit into the predetermined size of each button of the thumbnail on the menu page. As to the movie data, the processing section can extract the first frame of the movie data and resize the first frame to fit into the predetermined size of each button of the thumbnail on the menu page. The processing section can put together several thumbnail (e.g., 10, 20 , 30 and the like) into one group. Once the processing section can completely fill the menu page with the group of thumbnail, the processing section can create another menu page, and so on. After the processing section creates all menu pages, the processing section can create navigation links and commands between each menu pages so that the player for the removable optical storage medium can navigate the menu pages using a remote control for the player. The processing section can make each thumbnail link to a chapter of the digital photo album file including the still image or the movie corresponding to the thumbnail. In certain embodiments, the processing section can make the pointer for the index file so that the pointer can be a command to jump to designated the chapter or the segment of the digital photo album file. In certain embodiments, the processing section can make the pointer for each still image thumbnail data so that each pointer can be the command to jump to the chapter or the segment including the still image or the movie corresponding to each of the still thumbnail image data. For instance, in the case of the index file for the DVD, after the processing section creates all menu pages, the processing section can create navigation links and commands between each menu pages as indicated by the DVD video specification so that the DVD player can navigate the menu pages using a remote control. In certain embodiments, if the index file comprises several pages, the processing section can produce the index file so that after each page including the still thumbnail image data is displayed for a predetermined period, next page is displayed automatically. In certain embodiments, if the index file comprises several pages, the processing section can produce the index file so that after a page including the still thumbnail image data is displayed, it can be advanced to the next page manually by user's input to the remote controller, the control panel or the like of the player for the removable optical storage medium. In certain embodiments, the processing section can produce the index file so that the index file can be recorded in the DVD recording area as separate group as menu section to allow user to select when the DVD image is ready to be played back.

In certain embodiments, the processing section can decide the playback time of each still image data arbitrarily (e.g., 2 sec., 5 sec., 10 sec., and the like). Then, the processing section can calculate the total playback time by multiplying the playback time of each still image data by the number of the still image data and adding the playback time of the movie data to the result of multiplication. The processing section can produce the digital photo album file of which the total playback time is decided by the above way. If the background music data is incorporated into the digital photo album file, the processing section can produce the digital photo album file so that the background music can fade out when the display of the image data ends.

In certain embodiments, the processing section can produce the digital photo album file by the different way from the above based on the playback time of each still image data and the total playback time of the digital photo album file. In certain embodiments, the processing section can calculate temporal total playback time of the image data and compare the temporal total playback time of the image data with playback time of the background music data selected by the input section.

In certain embodiments, the processing section can calculate temporal playback time of each still image data based on the playback time of the background music data selected by the input section, the number of the still image data and the playback time of the movie data. For instance, the temporal playback time of each still image data can be calculated by subtracting the playback time of the movie data from the playback time of the background music data at first and dividing the result of the subtraction by the number of still image data.

In certain embodiments, after the calculation of the temporal playback time of each still image data, the processing section can compare the temporal playback time of each still image data with the time of the minimum time data and the time of the maximum time data to decide the playback time of each still image data. In certain embodiments, if the processing section judges that the temporal playback time of each still image data is less than the time of the minimum time data stored in the data storing section, the time of the minimum time data stored in the data storing section can be set as the playback time of each still image data by the processing section. In certain embodiments, if the processing section judges that the temporal playback time of each still image data is more than the time of the maximum time data stored in the data storing section, the time of the maximum time data stored in the data storing section can be set as the playback time of each still image data by the processing section. In certain embodiments, if the processing section judges that the temporal playback time of each still image data is not more than the time of the maximum time data and not less than the time of the minimum time data, the temporal playback time can be set as the playback time of each still image data by the processing section.

In certain embodiments, after deciding the playback time of each still image data, the processing section can calculate temporal total playback time of the image data based on the decided playback time of each still image data, the number of the still image data, the playback time of the movie data. For instance, the temporal total playback time of the image data can be calculated by multiplying the playback time of each still image data by the number of the still image data and adding the playback time of the movie data to the result of the multiplication.

In certain embodiments, after the calculation of the temporal total playback time of the image data, the processing section can compare the temporal total playback time of the image data with the playback time of the background music data to decide the total playback time of the digital photo album file. In certain embodiments, if the processing section judges that the temporal total playback time of the image data is longer than the playback time of the background music data selected by the input section, the temporal total playback time of the image data can be set as the total playback time of the digital photo album file by the processing section. In certain embodiments, if the processing section judges that the temporal total playback time of the image data is shorter than the playback time of the background music data, the playback time of the background music data can be set as the total playback time of the digital photo album file by the processing section.

In certain embodiments, the processing section can calculate the temporal playback time of each still image data, the playback time of each still image data, the temporal total playback time of the digital photo album file or the total playback time of the digital photo album file by utilizing a frame, not sec. or min., as an unit for the calculation. In certain embodiments, the frame can be an unit indicating how many sequential images are displayed during predetermined period (e.g., 1 sec.). For instance, if it is decided by certain format (e.g., video CD format, DVD format etc.) that 30 frames can be displayed during 1 sec., 10 sec. can be processed as 300 frames. In certain embodiments, the frame data (e.g., information about how many images are displayed during the predetermined period) can be stored in the data storing section.

In certain embodiments, the processing section can produce the digital photo album file by mixing and compressing the background music data and the image data into one file so that the display of the image data can start with the playback of the background music data. In certain embodiments, the processing section can produce the digital photo album file by compressing the background music file and the image data according to compression algorithm. For instance, if the CD (e.g., CD-R, CD-RW etc.) is used as the removable optical storage medium, the compression algorithm can be MPEG-1. If the DVD (e.g., DVD-R, DVD-RW, DVD+RW etc.) is used as the removable optical storage medium, the compression algorithm can be MPEG-2.

In certain embodiments, the processing section can compress the still image data whose format is JPEG format or other format according to the compression algorithm and can convert the still image data into certain compression format. Further, the processing section can compress the background music data whose format is WAVE format or other format according to the compression algorithm and can convert the background music data into the compression format. The processing section can divide the movie data whose format is AVI format, MOV format or other format into the audio data and the movie data not including the audio data at first, then can compress the audio data whose format is AVI format, MOV format or other format according to the compression algorithm and can convert the audio data into the compression format, and can compress the movie data not including the audio data, whose format is AVI format, MOV format or other format according to the compression algorithm and can convert the movie data not including the audio data into the compression format. After that, the processing section can mix the still image data, the movie data not including the audio data, the background music data and the audio data, whose formats are the compression format into one digital photo album file according to the video image related format (e.g., video CD format, DVD format (e.g., DVD-video specification, DVD-R specification and the like) etc.).

In certain embodiments, the processing section can produce the digital photo album file based on the total playback time of the digital photo album file calculated by the processing section.

In certain embodiments, the digital photo album file can be a video file (e.g., VOB file) so that the still image data and/or the movie data can be displayed sequentially with the playback of the background music data. In certain embodiments, the digital photo album file can comprise several segments or chapters. In certain embodiments, each segment or chapter can comprise one or several still image data to be displayed sequentially. In certain embodiments, each segment or chapter can comprise one or several movie data to be displayed sequentially. In certain embodiments, one segment or chapter can be composed of only still image data or only movie data and may not comprise both of still image data and movie data.

In certain embodiments, if the processing section judges that the temporal total playback time of the image data is longer than the playback time of the background music data, the processing section can produce the digital photo album file so that the background music file is played repeatedly until the display of the images data ends. In certain embodiments, if the processing section judges that the temporal total playback time of the image data is shorter than playback time of the background music data, the processing section can produce the digital photo album file so that the image data is displayed repeatedly until the playback of the background music data ends. In certain embodiments. if the calculating section judges that the temporal total playback time of the image data is longer than the playback time of the background music data, the processing section can produce the digital photo album file so that the background music data is played repeatedly until the display of the image data ends and when the display of the image data ends, the background music is faded out.

In certain embodiments, the processing section can produce the digital photo album file so that the background music data is played only during the display of the image data. In certain embodiments, the processing section can produce the digital photo album file so that the audio data included in the movie data is played only during the display of the movie data. In certain embodiments, the processing section can produce the digital photo album file so that while both of the background music data and the audio data are played simultaneously, the background music data can be played by using only one channel (e.g., a left channel or a right channel) of two stereo channels and the audio data can be played by using only the other channel (e.g., a right channel or a left channel) of the two stereo channels. In certain embodiments, the processing section can produce the digital photo album file so that while the background music data is played without the playback of the audio data, the background music data can be played by using the two stereo channels. In certain embodiments, the processing section can produce the digital photo album file so that while both of the background music data and the audio data are played simultaneously, the audio data can be played at higher level than level of the playback of the background music data. For instance, if the level of the playback of the audio data is 100, the level of the playback of the background music data can be from 50 to 80. In certain embodiments, the processing section can produce the digital photo album file so that when it is changed from the status of the playback of the background music data with the playback of the audio data to the status of the playback of the background music data without the playback of the audio data or in reverse thereof, the level of the playback of the background music data can be gradually changed.

In certain embodiments, the processing section can produce the digital photo album file so that the resolution of the still image data can be higher than the resolution of the movie data. For instance, if the removable optical storage medium is the CD, the resolution of the still image data can be 704×480 and the resolution of the movie data can be 352×240. If the removable optical storage medium is the DVD, the resolution of the still image data and the movie data can be 720×480.

Examples of the processing section consistent with certain embodiments of the invention include, but are not limited to, a CPU or a MPU, with a memory and/or software for the calculation and/or the producing the digital photo album file, if necessary. In certain embodiments, the processing section can be means for calculating temporal total playback time of the image data, comparing the temporal total playback time with the playback time of the background music data and producing the digital photo album file (in other words, digital photo album file producing means).

In certain embodiments, the processing section and the verification section can be one same component. In certain embodiments, the processing section and the verification section can be different components.

Producing a Digital Photo Album file 1

In certain embodiments, the maximum time and the minimum time for displaying each still image data can be established and be stored in the data storing section as the maximum time data and the minimum time data in advance. In certain embodiments, it is preferable that the maximum time can be from 5 sec. to 30 sec.. In certain embodiments, it is preferable that the minimum time can be 1 sec. to 5 sec.. For instance, 5 sec. can be stored as the minimum time data and 20 sec. can be stored as the maximum time data in the data storing section in advance.

In certain embodiments, one or several background music data can be stored in the data storing section in advance. In certain embodiments, the authorized data for verification can be stored in the data storing section in advance. In certain embodiments, the frame data can be stored in the data storing section in advance.

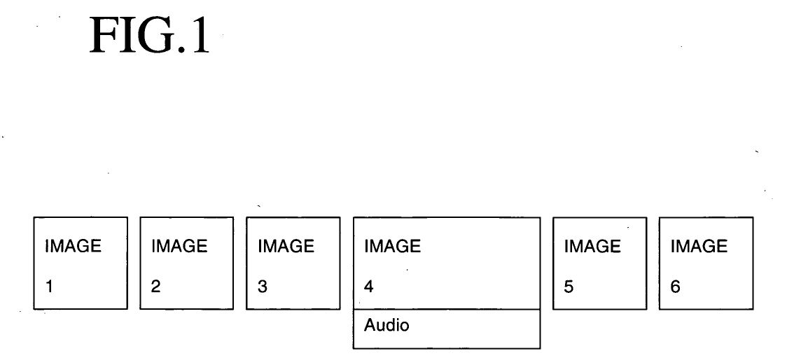

In certain embodiments, an user can take digital photograph and/or digital movie by the digital camera (e.g., a digital still camera and a digital video camera) and store the digital photograph and/or the digital movie in the image data recording medium and/or the server or the computer. In certain embodiments, the image data can comprise the still image data, whose format is JPEG format, or other format and/or the movie data, whose format is AVI format, MOV format or other format, having the audio data. In certain embodiments, the image data recording medium comprising the image data can be inserted into the reading section of the digital photo album producing apparatus. In certain embodiments, the. image data can be read from the inserted image data recording medium by the reading section and the read image data can be stored in the image data storing section temporally. In certain embodiments, the image data stored in the server or the computer can be read and sent to the reading section through the internet. Then, the reading section can obtain the image data. For instance, as illustrated in FIG. 1, the image data comprising five still image data (IMAGE 1, 2, 3, 5 and 6) and one movie data including audio data (IMAGE 4) of which playback time is 1 min. can be read from the image data recording medium or through the internet and be stored in the image data storing section temporally. In certain embodiments, if several kinds of data is stored in the image data recording medium, only standard image related file can be obtained by the reading section.

In certain embodiments, the image data stored in the image data storing section can be read and the still images and the movie (or one still image extracted from the movie) generally corresponding to the image data can be displayed on the display section. In certain embodiments, all of the still images and the movie can be displayed on one screen like thumbnail in the display section. In certain embodiments, several still images and/or the movie can be displayed in one page like thumbnail on the display section and other still images and/or the movie can be displayed in another page on the display section.

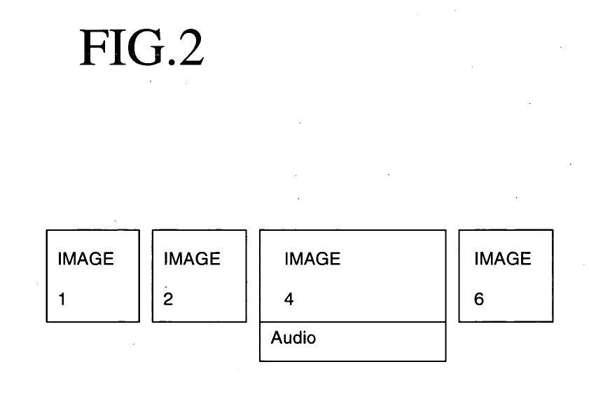

In certain embodiments, the image data which the user wants to include in the digital photo album file or the image data which the user does not want to included in the digital photo album can be selected by the operation of the user from the input section as the user sees the still images and/or the movie displayed on the display section. For instance, as illustrated in FIG. 2, the IMAGE 1, 2, 6 of the still image data and the IMAGE 4 of the movie data can be selected as the image data to be included in the digital photo album file.

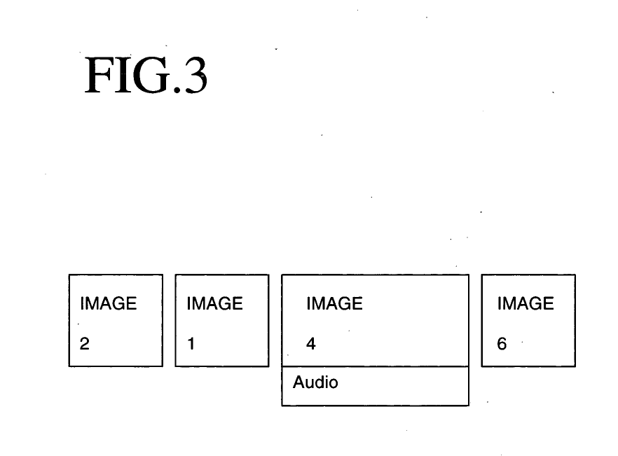

In certain embodiments, the user can change order of the display of the still image data and/or the movie data by the operation of the user from the input section. For instance, as illustrated in FIG. 3, the order of displaying image data can be changed from the order of IMAGE 1, 2, 4 and 6 to the order of IMAGE 2, 1, 4 and 6 according to the user's operation input by the input section. In certain embodiments, the user can change an orientation (e.g., a horizontal, a vertical and the like) of the still image and/or the movie by the operation of the user input by the input section.

In certain embodiments, reference information (e.g., a title, an artist, a reference number and the like) of the background music data stored in the data storing section can be displayed on the display section. In certain embodiments, the user can select background music data by the input section among the background music data stored in the data storing section as the user sees the reference information displayed on the display section. In certain embodiments, the background music data can be played from the sound output section for a predetermined period and the user can select the background music data after the user listens to the background music. For instance, the user can select BGM No. 3 of which the playback time is 3 min. 42 sec. among six background music data by the input section after listening to each of the background music.

In certain embodiments, the playback time of the image data can be calculated by the processing section. In certain embodiments, the temporal playback time of each still image data can be calculated by the processing section. Then, the playback time of each still image data can be decided by comparing the temporal playback time with the time of the maximum time data and the time of the minimum time data stored in the data storing section. The detail of the calculation is also described in the above APPARATUS section. For instance, at first, the calculating section can subtract 1 min. which is playback time of the movie data (IMAGE 4) from 3 min. 42 sec. which is the playback time of the background music data (BGM No. 3). The result of the subtraction is 2 min. 42 sec. Then, the 2 min. 42 sec. can be divided by 3 which is the number of still image data (IMAGE 2, 1 and 6). The result of the division is 54 sec. The 54 sec. is the temporal playback time of each still image data. Because the processing section can judge that the temporal playback time of each still image (54 sec.) is more than the time of the maximum time data (20 sec.) stored in the data storing section by comparing the temporal playback time with the time of the maximum time data and the time of the minimum time data, the maximum time (20 sec.) can be set as the playback time of each still image data by the processing section.

In certain embodiments, after the playback time of each still image data is decided, the temporal total playback time of the image data can be calculated by the processing section. Then, the total playback time of the digital photo album file can be decided by comparing the temporal total playback time of the image data with the playback time of the background music. For instance, after 20 sec. is decided as the playback time of each still image data, the temporal total playback time of the image data can be calculated by the processing section. Because the playback time of each still image is 20 sec., the number of the still image data is 3 (IMAGE 2, 1 and 6) and the playback time of the movie is 1 min. (IMAGE 4), the temporal total playback time of the image data is 2 min. (20 sec.×3+1 min. =2 min.). Because the 2 min. is shorter than 3 min. 42 sec. which is the playback time of the background music data (BGM No. 3), the 3 min. 42 sec. can be set as the total playback time of the digital photo album by the processing section. Therefore, the total playback time of the digital photo album file can be 3 min. 42 sec.

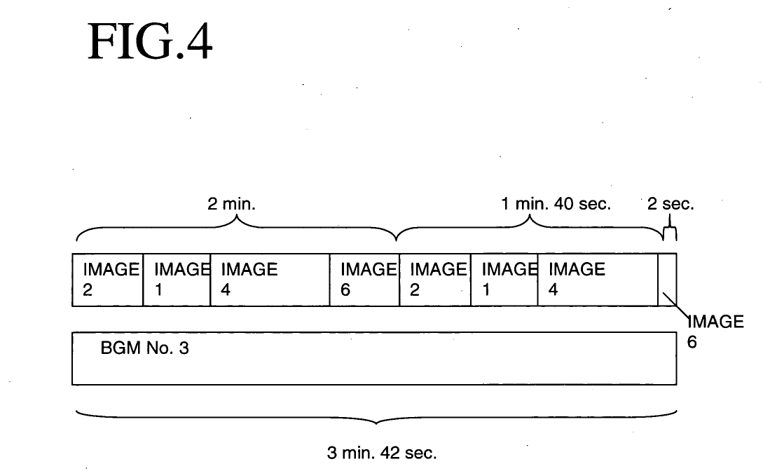

In certain embodiments, after the total playback time of the digital photo album file is decided by the processing section, an outline of the digital photo album file can be decided by the processing section. In certain embodiments, the outline of the digital photo album file can include the order of displaying each still image data and/or the movie data, the total playback time of the digital photo album file, the playback time of each still image data and/or the movie data, the playback time of the background music data, how many times the background music data or the image data is displayed or played repeatedly and the like. In certain embodiments, the outline can further include the orientation of each still image data and/or the movie data, the kind of the background music data. For instance, as illustrated in FIG. 4, the outline of the digital photo album file can be decided so that the image data can be displayed repeatedly until the playback of the background music ends because the playback time (3 min. 42 sec.) of the background music data is longer than the temporary total playback time (2 min.) of the image data. The difference between the playback time (3 min. 42 sec.) of the background music (BGM No. 3) and the temporary total playback time (2 min.) of the image data (IMAGE 2, 1, 4 and 6) is 1 min. 42 sec. During the 1 min. 42 sec., IMAGE 2, 1, and 4 can be displayed fully again, because the playback time of IMAGE 2 is 20 sec., the playback time of IMAGE 1 is 20 sec and the playback time of IMAGE 4 is 1 min. After the IMAGE 2, 1 and 4 is displayed again, the rest of the playback time is 2 sec. Therefore, as illustrated in FIG. 4, the processing section can decide the outline of the digital photo album file so that the IMAGE 2, 1 and 4 can be displayed fully again and only 2 sec. of the IMAGE 6 can be displayed after the IMAGE 2, 1, 4 and 6 is displayed once.

In certain embodiments, if the user selects that the background music is not played (no background music), the calculation of the temporal playback time of each still image data is not required and the minimum time data or the maximum time data can be set as the playback time of each still image data arbitrarily. Further, the calculation of the temporal total playback time of the digital photo album file is not required. Then, the total playback time of the digital photo album file can be calculated by multiplying the playback time of each still image data by the number of the still image data and adding the result of the multiplying to the playback time of the movie data.

In certain embodiments, the above calculation can be conducted by utilizing a frame as an unit, not time (e.g., sec. and min. etc.). For instance, in the above embodiments, if 30 frames can be displayed during 1 sec., the data recording section can record that 1 sec. is equal to 30 frames in advance, and the minimum time data can be stored as 150 frames (30 frames×5 sec.), the maximum time data can be stored as 600 frames (30 frames×20 sec.). Further, the temporal playback time of each still image data can be obtained as 1620 frames (30 frames×54 sec.) and the playback time of each still image data can be obtained as 600 frames. Further, the playback time of the movie data can be 1800 frames. The temporal total playback time of the digital photo image file can be 3600 frames. The total playback time of the digital photo image file can be 6660 frames. The playback time of the second IMAGE 6 can be 60 frames. By utilizing frames for the calculation, smaller unit than sec. can be utilized, the playback time can be controlled in more detail and decimal calculation can be avoided more.

In certain embodiments, if the playback time of the still image data which is displayed at the last of the digital photo album file (e.g., second IMAGE 6 of FIG. 4) is less than the playback time of other still image data, the digital photo album file can be produced so that the last still image data might not be included in the digital photo album file and the background music can be faded out and ended synchronizing with the end of the display of the image data which is just before the last still image data (e.g., second IMAGE 6 of FIG. 4). In certain embodiments, if the playback time of the movie data which is displayed at the last of the digital photo album file is less than the playback time of the original movie data, the digital photo album file can be produced so that the last movie data might not be included in the digital photo album file and the background music can be faded out and ended synchronizing with the end of the display of the image data which is just before the last movie data.

In certain embodiments, after the outline of the digital photo album file is decided, the digital photo album file can be produced by the processing section. In certain embodiments, the deciding process of the outline of the digital photo album file and the producing process of the digital photo album file can be separate process. In certain embodiments, the deciding process of the outline of the digital photo album file and the producing process of the digital photo album file can be consolidated. In certain embodiments, the digital photo album file can be produced by mixing and compressing the background music data and the image data comprising the still image data and/or the movie data including the audio data into one video file (e.g., VCD file, VOB file and the like) according to the algorithm of data compression (e.g., MPEG-1, MPEG-2) and the video related image format (e.g., VCD format, DVD format and the like) so that the display of the image data can start with the playback of the background music data and the display of the image data can end with the playback of the background music data.

In certain embodiments, the still image data whose format is JPEG format or other format can be compressed according to the compression algorithm and can be converted into certain compression format. Further, the background music data whose format is WAVE format or other format can be compressed according to the compression algorithm and can be converted into the compression format. The movie data whose format is AVI format, MOV format or other format can be divided into the audio data and the movie data not including the audio data at first, then the audio data whose format is AVI format, MOV format or other format can be compressed according to the compression algorithm and can be converted into the compression format, and the movie data not including the audio data, whose format is AVI format, MOV format or other format can be compressed according to the compression algorithm and can be converted into the compression format. After that, the still image data, the movie data not including the audio data, the background music data and the audio data, whose formats are the compression format can be mixed into one digital photo album file according to the video image related format (e.g., video CD format, DVD format etc.). In certain embodiments, the image data can be compressed so that the resolution of the still image data is same as or higher than the resolution of the movie data.

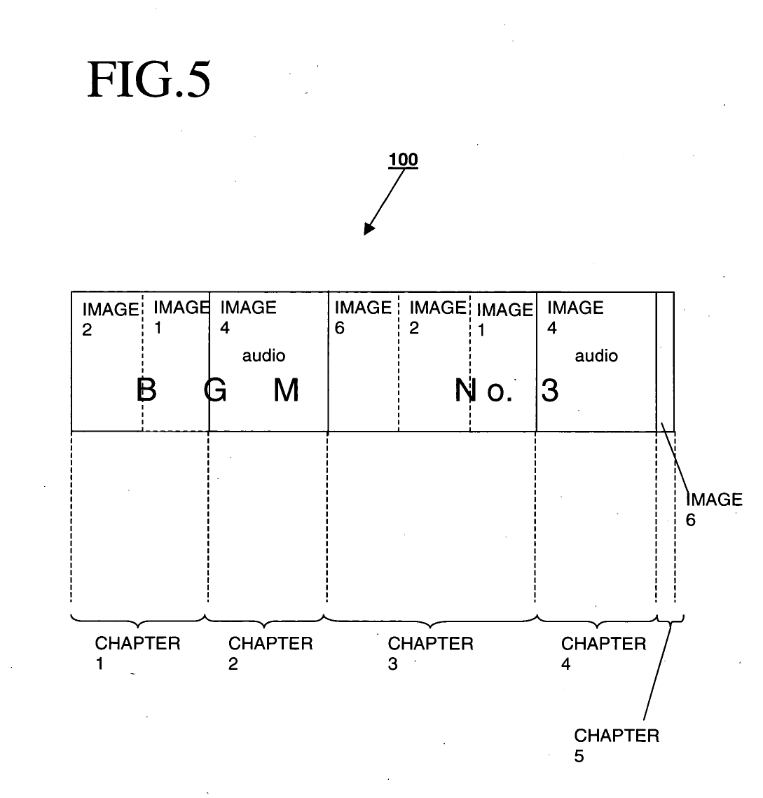

For instance, as illustrated in FIG. 5, the digital photo album file 100 can be produced by compressing the background music data (BGM No. 3 whose format is WAVE format) and the image data comprising the still image data (IMAGE 2, 1 and 6 whose formats are JPEG file), the movie data (IMAGE 4 whose format is AVI format) including the audio data (AUDIO whose format is AVI format) according to the algorithm of compression (e.g., MPEG-2) and mixing into one video file according to the video image related format (e.g., DVD-video specification of DVD format) so that the 20 sec. of each of the IMAGE 2,1, 4 and only 2 sec. of the IMAGE 6 can be displayed again after the IMAGE 2, 1, 4 and 6 is displayed fully once, and the display of the first IMAGE 2 can start with the playback of the BGM No. 3 and the display of the second IMAGE 6 can end with the playback of the BGM No. 3. The digital photo album file 100 can comprise 5 chapters (CHAPTER 1, 2, 3, 4, and 5). In certain embodiments, each chapter can be comprised of only one or more still image data, or only one or more movie data. In certain embodiments, one chapter can be comprised of only one movie data. In certain embodiments, each chapter might not comprise both of still image data and movie data. In certain embodiments, the background music data can be divided into several parts so that each part can be included in each chapter of the digital photo album file. As illustrated in FIG. 5, the CHAPTER 1 can comprise IMAGE 2 and 1 (still image data) and first part of BGM No. 3. The CHAPTER 2 can comprise IMAGE 4 (movie data) including audio data and second part of BGM No. 3. The CHAPTER 3 can comprise IMAGE 6, 2 and 1 (still image data) and third part of BGM No. 3. The CHAPTER 4 can comprise IMAGE 4 (movie data) including AUDIO (audio data) and fourth part of BGM No. 3. The CHAPTER 5 can comprise IMAGE 6 (still image data) of which playback time is only 2 sec. and fifth (final) part of BGM No. 3.

In certain embodiments, maximum number (e.g., 10, 20, 30 and the like) of the still image data which can be included in one chapter can be established. For instance, in the case the maximum number of the still image data in one chapter is 20 still images, if 25 still image data are included sequentially, the first 20 still image data can be included in one chapter and the other 5 still image data can be included in. other chapter.

In certain embodiments, the digital photo album file can be produced so that while the background music data and the audio data are played simultaneously, the background music data can be played by using only one channel (e.g., a left channel or a right channel) of two stereo channels and the audio data can be played by using only the other channel (e.g., a right channel or a left channel) of the two stereo channels. In certain embodiments, the digital photo album file can be produced so that while the background music data is played without playback of the audio data, the background music data can be played by using the two stereo channels. In certain embodiments, the digital photo album file can be produced so that while the background music data and the audio data are played simultaneously, the audio data can be played at higher level than level of the background music data. For instance, as illustrated in FIG. 5, the digital photo album file 100 can be produced so that while each of CHAPTER 1, 3, and 5 is reproduced, the background music data (BGM No. 3) can be played by using the two stereo channels. While each of CHAPTER 2 and 4 is reproduced, the background music data (BGM No. 3) can be played by using only the left channel and the audio data (AUDIO) can be played by using only the right channel at higher level (e.g., Level 100) than the level of the left channel (e.g., Level 60). In certain embodiments, as illustrated in FIG. 5, if the digital photo album file 100 is reproduced, the display of the still image data (IMAGE 2) can start with the playback of the background music data (BGM No. 3) simultaneously.

In certain embodiments, the user can input a reference information (e.g., a title, a place of photo, a name of man and so on) of the digital photo album file by the input section. In certain embodiments, the processing section can produce the digital photo album file so that the reference information is included in the digital photo album file.

Producing a Digital Photo Album file 2

In certain embodiments, fixed playback time (e.g., 2 sec., 5 sec., 10 sec., and the like) for displaying each still image data can be stored in the data storing section in advance. For instance, the fixed playback time (10 sec.) can be stored in the data storing section.

In certain embodiments, one or several background music data can be stored in the data storing section in advance. In certain embodiments, the authorized data for verification can be stored in the data storing section in advance. In certain embodiments, the frame data can be stored in the data storing section in advance.

Then, the reading section can obtain the image data. For instance, as illustrated in FIG. 1, the image data comprising five still image data (IMAGE 1, 2, 3, 5 and 6) and one movie data including audio data (IMAGE 4) of which playback time is 1 min. can be obtained and be stored in the image data storing section temporally.

In certain embodiments, the image data which the user wants to include in the digital photo album file or the image data which the user does not want to included in the digital photo album can be selected by the operation of the user from the input section as the user sees the still images and/or the movie displayed on the display section. For instance, as illustrated in FIG. 2, the IMAGE 1, 2, 6 of the still image data and the IMAGE 4 of the movie data can be selected as the image data to be included in the digital photo album file.

In certain embodiments, the user can change order of the display of the still image data and/or the movie data by the operation of the user from the input section. For instance, as illustrated in FIG. 3, the order of display of image data can be changed from the order of IMAGE 1, 2, 4 and 6 to the order of IMAGE 2, 1, 4 and 6 according to the user's operation input by the input section.

In certain embodiments, the user can select background music data by the input section among the background music data stored in the data storing section as the user sees the reference information displayed on the display section. For instance, the user can select BGM No. 3 of which the playback time is 3 min. 42 sec. among six background music data by the input section after listening to each of the background music.

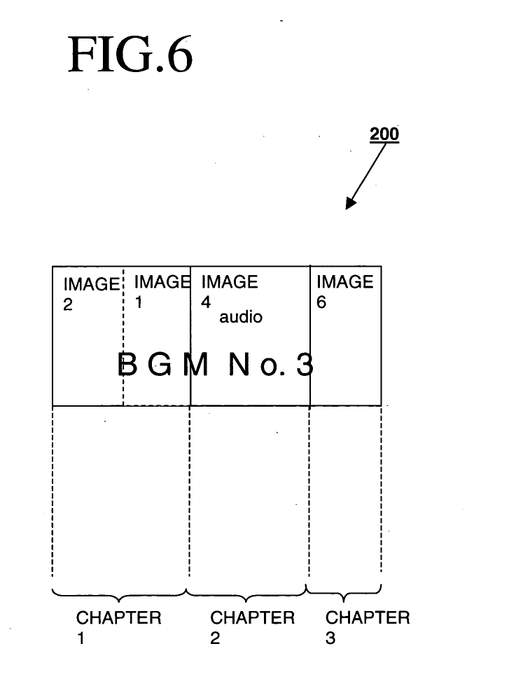

In certain embodiments, the total playback time of the digital photo album file can be calculated by multiplying the fixed playback time of each still image data by the number of the still image data and adding the result of the multiplying to the playback time of the movie data. As illustrated in FIG. 6, the total playback time can be 1 min. 30 sec. ( 10 sec×3+1 min.=1min. 30 sec.) If the total playback time is shorter than the playback time of the background music data, the digital photo album can be produced so that the background music can fade out when the display of the image data ends. If the total playback time is longer than the playback time of the background music data, the digital photo album can be produced so that the background music can be repeated until the display of the image data ends. For instance, the total playback time (1 min. 30 sec.) is shorter than the playback time (3 min, 42 sec) BGM No. 3. Therefore, the BGM No. 3 can fade out when the display of the image data ends.

In certain embodiments, the above calculation can be conducted by utilizing a frame as an unit, not time (e.g., sec. and min. etc.).

In certain embodiments, the digital photo album file can be produced by mixing and compressing the background music data and the image data comprising the still image data and/or the movie data including the audio data into one video file (e.g., VCD file, VOB file and the like) according to the algorithm of data compression (e.g., MPEG-1, MPEG-2) and the video related image format (e.g., VCD format, DVD format and the like) so that the display of the image data can start with the playback of the background music data and the display of the image data can end with the playback of the background music data.

For instance, as illustrated in FIG. 6, the digital photo album file 200 can be produced by compressing the background music data (BGM No. 3 whose format is WAVE format) and the image data comprising the still image data (IMAGE 2, 1 and 6 whose formats are JPEG file), the movie data (IMAGE 4 whose format is AVI format) including the audio data (AUDIO whose format is AVI format) according to the algorithm of compression (e.g., MPEG-2) and mixing into one video file according to the video image related format (e.g., DVD-video specification of DVD format) so that the 10 sec. of each of the IMAGE 2, 1, 1 min. of the IMAGE 4 and 10 sec. of the IMAGE 6 can be displayed, and the display of the first IMAGE 2 can start with the playback of the BGM No. 3 and the playback of the BGM No. 3 can fade out when the display of the IMAGE 6 ends. The digital photo album file 200 can comprise 3 chapters (CHAPTER 1, 2 and 3). As illustrated in FIG. 6, the CHAPTER 1 can comprise IMAGE 2 and 1 (still image data) and first part of BGM No. 3. The CHAPTER 2 can comprise IMAGE 4 (movie data) including audio data and second part of BGM No. 3. The CHAPTER 3 can comprise IMAGE 6 (still image data) and third part of BGM No. 3.

In certain embodiments, the above explanation about PRODUCING A DIGITAL PHOTO ALBUM FILE 1 can be applied to the PRODUCING A DIGITAL PHOTO ALBUM FILE 2.

Producing an Index File

In certain embodiments, after the image data and the background music data are compressed and mixed into one file, the index file can be produced.

In certain embodiments, the template file can be taken with the layout of button count of thumbnail, placement and size for each menu page. The individual still image data can be resized to fit into the predetermined size of each button of the thumbnail on the menu page. As to the movie data, the first frame of the movie data can be extracted and the first frame can be resized to fit into the predetermined size of each button of the thumbnail on the menu page. Several thumbnail (e.g., 10, 20, 30 and the like) can be put together into one group. Once the menu page can be completely be filled with the group of thumbnail, another menu page can be created, and so on. After all menu pages are created, navigation links and commands can be created between each menu pages so that the player for the removable optical storage medium can navigate the menu pages using a remote control for the player. Each thumbnail can be linked to a chapter of the digital photo album file including the still image or the movie corresponding to the thumbnail theoretically. The pointer can be created for the index file so that the pointer can be the command to jump to the designated chapter or segment. The pointer can be created for each of the still thumbnail image data so that the pointer can be the command to jump to the chapter or the segment of the digital photo album file including the still image or the movie corresponding to each of the still thumbnail image data.

For instance, in the case of the digital photo album file 100 in FIG. 5, the thumbnail of IMAGE 2, 1, 4, 6, 2,1, 4 and 6 can be produced. Then the pointer, which is a command to jump to designated chapter, for each thumbnail of IMAGE 2, 1, 4, 6, 2, 1, 4 and 6 can be created so that the both of thumbnails of IMAGE 2 and 1 can be linked to the beginning of CHAPTER 1 of the digital photo album file 100 theoretically, the thumbnail of IMAGE 4 can be linked to the beginning of CHAPTER 2 theoretically, all of the thumbnails of IMAGE 6, 2 (2^{nd} time) and 1 (2^{nd} time) can be linked to the beginning of CHAPTER 3 theoretically, the thumbnail of IMAGE 4 (2_{nd} time) can be linked to the beginning of CHAPTER 4 theoretically and the thumbnail of IMAGE 6 (2_{nd} time) can be linked to the beginning of CHAPTER 5 theoretically. In other words, the pointer for the both of thumbnails of IMAGE 2 and 1 can be command to jump to the beginning of CHAPTER 1 of the digital photo album file 100, the pointer for the thumbnail of IMAGE 4 can be command to jump to the beginning of CHAPTER 2, the pointer for all of the thumbnails of IMAGE 6, 2 (2_{nd} time) and 1 (2_{nd} time) can be the command to jump to the beginning of CHAPTER 3, the pointer for the thumbnail of IMAGE 4 (2_{nd} time) can be the command to jump to the beginning of CHAPTER 4 and the pointer for the thumbnail of IMAGE 6 (2_{nd} time) can be the command to jump to the beginning of CHAPTER 5. The index file can comprise those pointers.

For instance, in the case of the digital photo album file 200 in FIG. 6, the thumbnail of IMAGE 2, 1, 4 and 6 can be produced. Then the pointer for each thumbnails can be created so that the pointer for each thumbnails of IMAGE 2 and IMAGE 1 can be a command to jump to the beginning of CHAPTER 1 of the digital photo album file 200, the pointer for the thumbnail of IMAGE 4 can be a command to jump to the beginning of CHAPTER 2 and the pointer for the thumbnail of IMAGE 6 can be a command to jump to the beginning of CHAPTER 3.

In certain embodiments, if the index file comprises several pages, the index file can be produced so that after each page including the still thumbnail image data is displayed for a predetermined period, next page can be displayed automatically. In certain embodiments, if the index file comprises several pages, the index file can be produced so that after one page including the still thumbnail image data is displayed, it can be advanced to next page manually by user's input to the remote controller, the control panel or the like of the player for the removable optical storage medium.

Recording a Digital Photo Album File and an Index File

In certain embodiments, the user can insert the removable optical storage medium into the recording section of the digital photo album producing apparatus.

In certain embodiments, the removable optical storage medium inserted into the digital photo album producing apparatus can be verified by the. verification section whether the inserted removable optical storage medium is authorized to record the digital photo album file or not. In certain embodiments, the verification can be conducted by confirming whether the authorized data is recorded or stamped in the removable optical storage medium or not. In certain embodiments, the authorized data recorded or stamped in the removable optical storage medium which is inserted into the digital photo album producing apparatus can be compared with the authorized data stored in the data storing section. If it is judged that the authorized data recorded or stamped in the removable optical storage medium is consistent with the authorized data stored in the data storing section, such removable optical storage medium can be regarded as the authorized medium. In certain embodiments, if the verification section judges that the removable optical storage medium is not authorized, certain message such as “THIS MEDIUM IS NOT AUTHORIZED TO RECORD DIGITAL PHOTO ALBUM. SO, PLEASE INSERT AN AUTHORIZED MEDIUM INTO THE MACHINE.” can be displayed on the display section and the. non-authorized removable optical storage medium can be put out from the digital photo album producing apparatus.

In certain embodiments, if it is verified that the inserted removable optical storage medium is authorized, the digital photo album file and the index file can be recorded onto the removable optical storage medium by the recording section according to the video image related format (e.g., video CD format, DVD format etc.). In certain embodiments, the index file can be recorded in the DVD recording area as separate group as menu section to allow user to select when the DVD image is ready to be played back. In certain embodiments, the original image data (in other words, raw data) originally stored in the image data recording medium can be recorded onto the removable optical storage medium in addition to the digital photo album file and the index file by the recording section. In certain embodiments, after finishing the recording, the removable optical storage medium can be put out from the digital photo album producing apparatus.

In certain embodiments, after finishing the recording or after finishing the producing the digital photo album file, the image data stored in the image data storing section can be deleted.

Reproducing a Digital Photo Album File and an Index File

In certain embodiments, the digital photo album file and/or the index file can be decoded and displayed on a display apparatus such as a liquid crystal display (LCD), a Braun tube, a cathode ray tube (CRT) and a plasma display panel by reproducing the removable optical storage medium by the player for the removable optical storage medium even if the removable optical storage is not reproduced by the computer.

In certain embodiments, if the digital photo album file is reproduced, the still image and the movie recorded in the removable optical storage medium can be displayed on the display apparatus sequentially by displaying a serial of still image files.

In certain embodiments, if the index file is reproduced, the still thumbnail image can be displayed on the display apparatus. In certain embodiments, after each page including the still thumbnail image data is displayed for a predetermined period (e.g., 3 sec, 5 sec, 10 sec, 20 sec and so on), next page can be displayed automatically. In certain embodiments, after each page including the still thumbnail image is displayed, it can be advanced to the next page manually by user's input from the remote controller, the control panel or the like of the player for the removable optical storage medium. Each thumbnail image is linked with the beginning of the each chapter or segment of the digital photo album file theoretically. Therefore, if the user selects one thumbnail image by a controller of the player, the chapter including the still image data or the movie data corresponding to the selected thumbnail can be reproduced.

### EXAMPLE

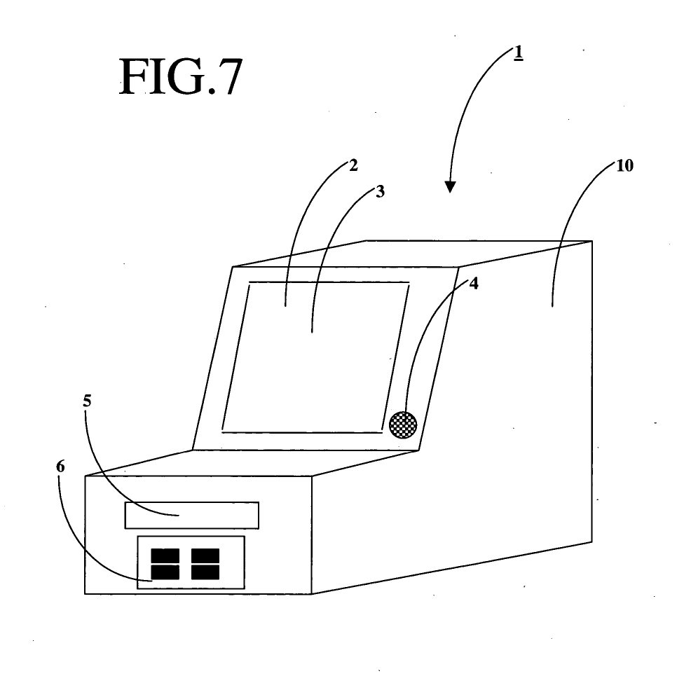

In certain embodiments, as illustrated in FIG. 7, the digital photo album producing apparatus (e.g. Photo Kiosk 1) can comprise a case 10, a display section (e.g., a CRT monitor 2), an input section (e.g., a touch screen 3), a sound output section (e.g., a speaker 4), a reading section and a recording section (e.g., a CD/DVD reader/writer 5 and a digital memory card reader/writer 6 as both of the reading section and the recording section). In certain embodiments, the digital memory card reader/writer 6 can read and/or write digital data from and/or onto a Memory Stick, a Compact Flash, a SD memory card, and a Smart Media. In certain embodiments, as illustrated in FIG. 7, the Photo Kiosk 100 can further comprise an image data storing section and a data storing section (e.g., a hard disk 8 as both of the image data storing section and the data storing section) and a processing section and a verification section (e.g., a CPU 9 and a RAM 7 with software as the processing section and the verification section). In certain embodiments, the CPU 9 can control timing of action, operation, start and stop of action of all of the sections which connect with the CPU 9 according to various software stored in the hard disk 8 or the RAM 7.

In certain embodiments, the maximum time data (e.g., 20 sec.) and the minimum time data (e.g., 5 sec.) for displaying each still image data can be established and be stored in the hard disk 8 as the data storing section in advance.

In certain embodiments, the background music data of six background music (BGM No. 1, 2, 3, 4, 5 and 6) can be stored in the hard disk 8 as the data storing section in advance. In certain embodiments, the format of the background music data stored in the hard disk 8 can be WAVE format.

In certain embodiments, the correct manufacturing code (e.g., 34567) as the authorized data can be stored in the hard disk 8 as the data storing section beforehand.

In certain embodiments, an user can take digital photograph and/or digital movie by the digital camera and store the still image data and/or the movie data in the image data recording medium (e.g., a SD memory card). In certain embodiments, the SD memory card storing the image data including the still image data (e.g., IMAGE 1, 2, 3, 5 and 6) and the movie data (e.g., IMAGE 4 of which playback time is 1 min.) having the audio data can be inserted into the digital memory card reader/writer 6 as the reading section. In certain embodiments, the format of the still image data stored in the SD memory card can be JPEG format. In certain embodiments, the format of the movie data stored in the SD memory card can be AVI format. In certain embodiments, the still image data whose format is JPEG format and the movie data whose format is AVI format can be included in the file under DCIM directory recorded in the SD memory card. In certain embodiments, the SD memory card can store Microsoft Word file in addition to the image data. In certain embodiments, the memory card reader/writer 6 can read only the image data (e.g., IMAGE 1, 2, 3, 4, 5 and 6) included in the file under DCIM directory from the SD memory card and the image data (e.g., IMAGE 1, 2, 3, 4, 5 and 6) whose formats are same with original image data can be stored in the hard disk 8 as the image data storing section temporally.

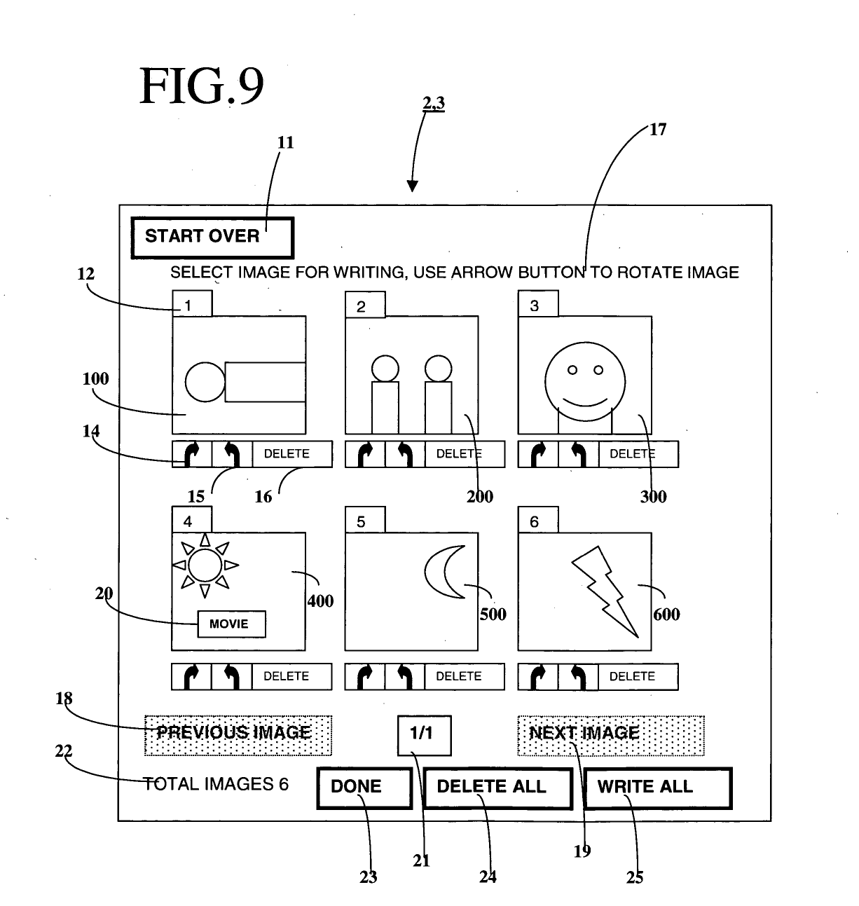

In certain embodiments, as illustrated in FIG. 9, the IMAGE 1, 2, 3, 4, 5 and 6 can be read from the hard disk 8 and the still images generally corresponding to IMAGE 1 (100), 2 (200), 3 (300), 5 (500) and 6 (600) and the still image of the first frame of the movie data of IMAGE 4 (400) can be displayed on the CRT monitor 2.

In certain embodiments, an instruction message 17 can be displayed on the CRT monitor 2. In certain embodiments, a reference number 12 of each image data can be displayed above each of the image on the CRT monitor 2. In certain embodiments, a page number 21 can be displayed on the CRT monitor 2. As illustrated in FIG. 9, 1/1 shows that the total number of all pages for displaying the image data is 1 and page 1 is now displayed. In certain embodiments, total number of image data 22 can be displayed on the CRT monitor 2. In certain embodiments, a movie mark 20 can be displayed within the still image 400 of the first frame of the movie data on the CRT monitor 2 to show the image data is the movie data.

In certain embodiments, a START OVER button 11 to start over the process of the producing the digital photo album can be displayed on the CRT monitor 2. If an user touches the portion of the touch screen 3 as the data input section corresponding to the START OVER button 11, the user can start over the process of the producing of the digital photo album from the beginning.

In certain embodiments, page change buttons 18, 19 can be displayed on the CRT monitor 2. If an user touches the portion of the touch screen 3 corresponding to the page change button 18, 19, the page displaying the image data can be changed. If the user touches the page change button of “PREVIOUS IMAGE” 18, a page displayed on the CRT monitor 2 will go back to the previous page. If the user touches the page change button of “NEXT IMAGE” 19, a page displayed on the CRT monitor 2 will go forward to the next page. As illustrated in FIG. 9, because the total number of image data is six and the number of the displaying page is only one, the page change button is unnecessary in this embodiment and the displayed page change buttons 18, 19 are fuzzy.

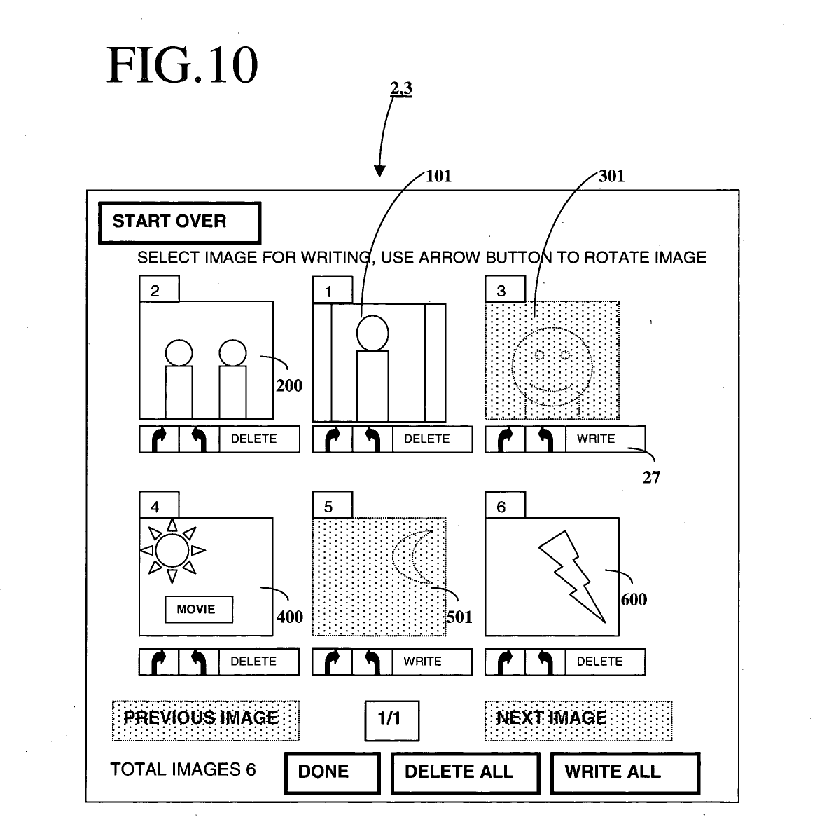

In certain embodiments, if the user touches the portion of the touch screen 3 corresponding to each image (100, 200, 300, 400, 500, 600) and drug, the user can change the order of the displaying of the image data. As illustrated in FIG. 10, if the user touches the portion of the touch screen 3 corresponding to the IMAGE 1 (100) and drug to the place between the IMAGE 2 (200) and IMAGE 3 (300), the order of the displaying of the image data changes and the first image to be displayed becomes IMAGE 2 (200) and the second image to be displayed becomes the IMAGE 1 (101).

In certain embodiments, image rotation buttons 14, 15 can be displayed below each image on the CRT monitor 2. If an user touches the portion of the touch panel 3 corresponding to the image rotation buttons 14, 15, the image which corresponding to the image rotation buttons can be rotated by 90 degrees. As illustrated in FIG. 10, if the user touches the right rotation button 14, the IMAGE 1 (101) can be displayed in the status rotated by 90 degrees clockwise. If user touches the left rotation button 15, the IMAGE 1 (100) can be rotated by 90 degrees counterclockwise.

In certain embodiments, image deleting buttons 16 can be displayed below each image on the CRT monitor 2. If an user does not want to include certain image data in the digital photo album file, the user can touch the portion of the touch screen 3 corresponding to the image deleting button 16 which is below the image which the user does not want to include and the image data can be prohibited from being included in the digital photo album file. As illustrated in FIG. 10, if the user touches the portion of the touch screen 3 corresponding to the image deleting button 16 below the IMAGE 3 and 5 (300, 500) which the user does not want to include, the displayed IMAGE 3 and 5 (301, 501) can be fuzzy and IMAGE 3 and 5 can be prohibited from being included in the digital photo album file. If the user wants to include the image data for which the image deleting button has been already touched, the user can touch the image writing button 27 to include the image data in the digital photo album file. As illustrated in FIG. 9, in this embodiment, if user does not touch any image deleting button 16, all of the image data can be included in the digital photo album file.

In certain embodiments, an all image deleting button 24 can be displayed on the CRT monitor 2. If an user touches the portion of the touch screen 3 corresponding to the all image deleting button 24, all of the image data displayed in the current page can be specified as the image data not to be included in the digital photo album file.

In certain embodiments, an all image writing button 25 can be displayed on the CRT monitor 2. If an user touches the portion of the touch panel 3 corresponding to the all image writing button 25, all of the image data displayed in the current page can be specified as the image data to be included in the digital photo album file. In this embodiments, even if the user does not touch the all image writing button 25, it is originally established that all of the image data are included in the digital photo album file.

In certain embodiments, a finish button 23 can be displayed on the CRT monitor 2. If an user touches the portion of the touch screen 3 corresponding to the finish button 23, the process of selecting image, rotating image and changing order of image can be completed, the image data to be included in the digital photo album file, the orientation of image data and the order of image data can be fixed and the next step can start. In certain embodiments, the next step may be the step of selecting the background music data, the step of inputting the reference information of the digital photo album file or the step of producing the digital photo album file.

As illustrated in FIG. 10, in this embodiment, the IMAGE 1, 2, 4 and 6 are selected as the image data to be included in the digital photo album file and the order of the image data is as IMAGE 2, 1, 4 and 6 and the orientation of IMAGE 2, 4 and 6 are horizontal and the orientation of IMAGE 1 is vertical.

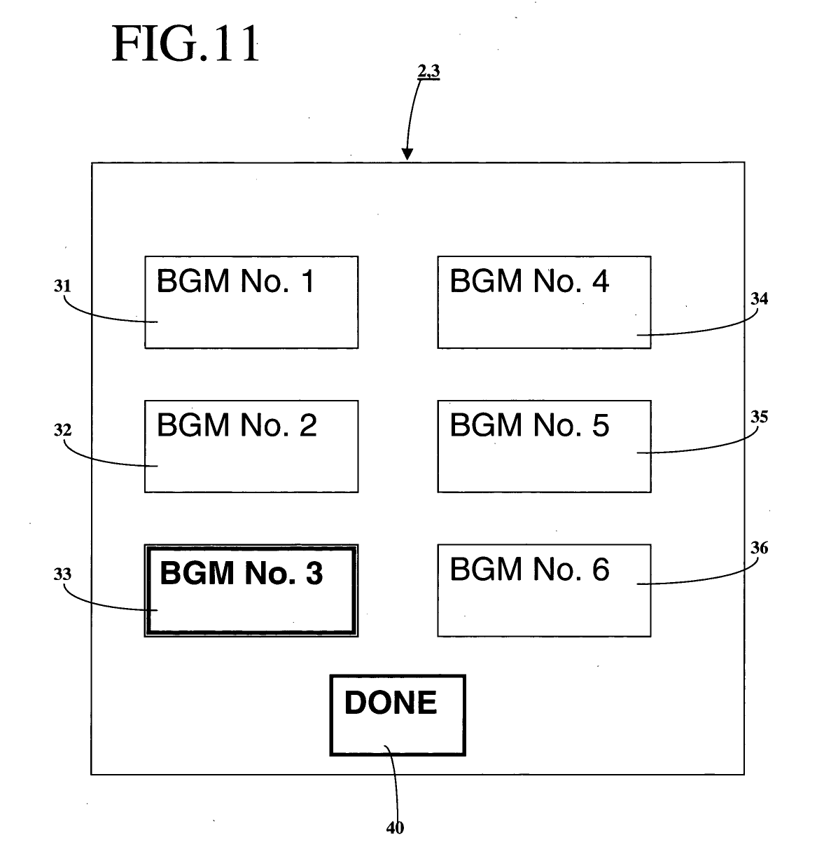

In certain embodiments, as illustrated in FIG. 11, after the user touches the finish button 23, background music buttons (31, 32, 33, 34, 35, 36) for the several background music data (BGM. No. 1, 2, 3, 4, 5 and 6) stored in the hard disk 8 can be displayed on the CRT monitor 2. In certain embodiments, in the background music buttons, the reference number of the background music data as the reference information can be displayed. If an user touches the portion of the touch screen 3 as the selecting section corresponding to each background music button (e.g., 33), the background music (BGM No. 3) can be played for predetermined period (e.g., 30 sec.) from the speaker 4 and the user can select the background music data after the user listens to the background music. If the user decides which background music data is selected, the user can touch the background music button (e.g., 33) which is corresponding to the background music data which the user wants to include in the digital photo album file and then touch a finish button 40. If the user touches the finish button 40, the background music data (BGM No. 3) can be fixed.

In certain embodiments, in the next step, as explained in the above PRODUCING A DIGITAL PHOTO ALBUM FILE 1 referring FIG. 4, the CPU 9 as the processing section with the RAM 7 and the software for calculation can calculate the temporal playback time of each still image, the playback time of each still image data, the temporal total playback time of the image data, the total playback time of the digital photo album file.

Then, as explained in the above PRODUCING A DIGITAL PHOTO ALBUM FILE 1 referring FIG. 5, the CPU 9 as the processing section with the RAM 7 and the software for producing the digital photo album file can produce the digital photo album file 100 as one VOB file based on the still image data of IMAGE 2, 1 and 6, the movie data of IMAGE 4 including the audio data, the background Music data of BGM No. 3, order information of IMAGE 2, 1, 4 and 6, orientation information (IMAGE 2, 6 are horizontal orientation and IMAGE 1 is vertical orientation) and the like. In certain embodiments, the still image data (IMAGE 2, 1 and 6) whose format is JPEG format can be compressed according to MPEG-2 format. In certain embodiments, the resolution of the compressed still image data can be 720×480. In certain embodiments, the background music data (BGM No. 3) whose format is WAVE format can be compressed according to MPEG-2. In certain embodiments, the movie data (IMAGE 4 and AUDIO) whose format is AVI format can be separated into the audio data (AUDIO) and the movie data (IMAGE 4) not including the audio data at first, then the audio data (AUDIO) whose format is AVI format can be compressed according to MPEG-2 format, and the movie data (IMAGE 4) not including the audio data, whose format is AVI format can be compressed according to MPEG-2 format. In certain embodiments, the resolution of the compressed movie data can be 720×480. After that, the compressed still image data (IMAGE 2, 1 and 6) whose format is MPEG-2 format, the compressed movie data (IMAGE 4) not including the audio data, whose format is MPEG-2 format, the compressed background music data (BGM No. 3) whose format is MPEG-2 format and the compressed audio data (AUDIO) whose format is MPEG-2 can be mixed into one digital photo album file including 5 chapters according to the DVD-video specification and DVD-R specification of the DVD format. In certain embodiments, the maximum number of the still image data which can be included in one chapter can be 20 still image data. In certain embodiments, the maximum number of the movie data which can be included in one chapter can be 1 movie data. One digital photo album according to the DVD-video specification can include up to 99 chapters.

In certain embodiments, the user can input a title of the digital photo album file from the touch screen 3 as the input section of which corresponding portion to the keyboard displayed on the CRT monitor 2. In certain embodiments, the CPU 9 can produce the digital photo album file so that the title is included in the digital photo album file.

In certain embodiments, after the CPU 9 produces the digital photo album file, the CPU 9 with software produces the index file.

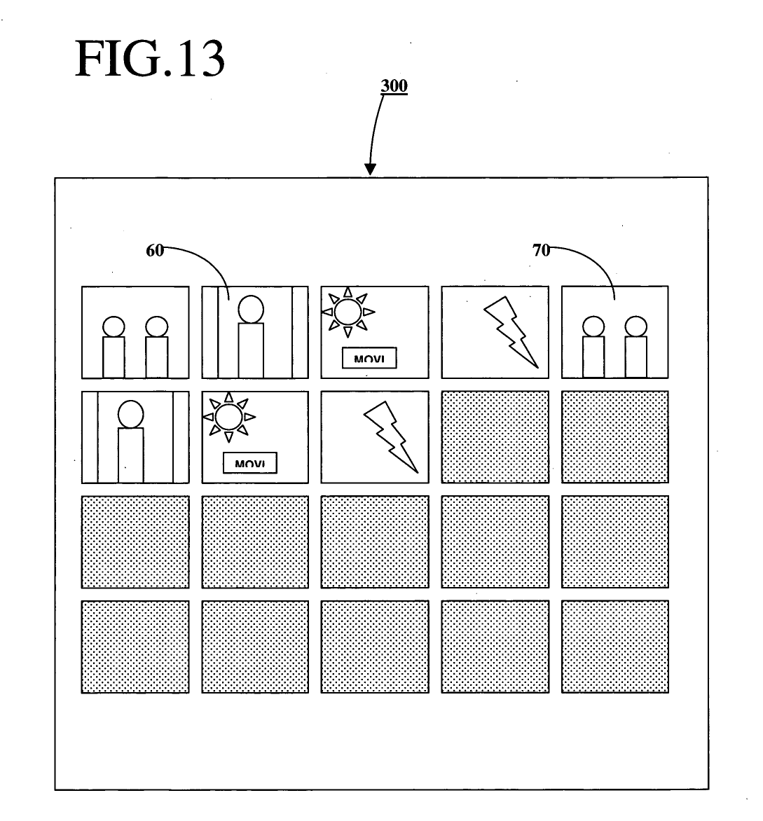

In certain embodiments, the CPU 9 can take the template file with the layout of button count of thumbnail (e.g., 20 thumbnails in 1 page), placement and size for each menu page. The CPU 9 can resize the individual still image data (IMAGE 2, 1, 6, 2, 1 and 6) to fit into the predetermined size of each button of the thumbnail on the menu page. As to the movie data (IMAGE 4), the CPU 9 can extract the first frame of the movie data (IMAGE 4) and resize the first frame to fit into the predetermined size of each button of the thumbnail on the menu page. As illustrated in FIG. 13, the CPU 9 can fill the menu page 50 with all of the thumbnails 51. At most 20 thumbnails can be incorporated into one menu page. If the image data can include more than 20 data in total of the still image data and the movie data, the CPU 9 produce another menu page after producing one menu page. After the CPU 9 creates all menu pages, the CPU 9 can link each thumbnail to a beginning of the chapter of the digital photo album file including the still image or the movie corresponding to the thumbnail.

For instance, as illustrated in FIG. 13, in the case of the digital photo album file 100 in FIG. 5, the thumbnail of IMAGE 2, 1, 4, 6, 2, 1, 4 and 6 can be produced, then the both of thumbnails of IMAGE 2 and 1 can be linked to the beginning of CHAPTER 1 of the digital photo album file 100, the thumbnail of IMAGE 4 can be linked to the beginning of CHAPTER 2, all of the thumbnails of IMAGE 6, 2 (2_{nd} time) and 1 (2_{nd} time) can be linked to the beginning of CHAPTER 3, the thumbnail of IMAGE 4 (2_{nd} time) can be linked to the beginning of CHAPTER 4 and the thumbnail of IMAGE 6 (2nd time) can be linked to the beginning of CHAPTER 5.

In certain embodiments, if the index file comprises several pages, the CPU 9 can produce the index file so that after each page including the still thumbnail image data is displayed for a predetermined period, next page can be displayed automatically.

In certain embodiments, the user can insert the DVD-R on which the correct manufacturing code (e.g., 34567) is stamped beforehand by the manufacturer into the CD/DVD reader/writer 5 as the recording section.

In certain embodiments, the DVD-R inserted into the Photo Kiosk 100 can be verified by the CPU 9 as the verification section with the RAM 7 and the software for the verification whether the DVD-R is authorized to record the digital photo album file or not by comparing the manufacturing code (34567) stamped on the DVD-R and read by the CD/DVD reader/writer 5 with the manufacturing code (34567) stored in the hard disk 8. In certain embodiments, if the CPU 9 judges that the DVD-R is not authorized, certain message such as “THIS MEDIUM IS NOT AUTHORIZED TO RECORD DIGITAL PHOTO ALBUM. SO, PLEASE INSERT AN AUTHORIZED MEDIUM INTO THE MACHINE.” can be displayed on the CRT monitor 2 and the non-authorized DVD-R can be put out from the Photo Kiosk 1.

In certain embodiments, if the CPU 9 judges that the manufacturing code stamped on the DVD-R is consistent with the manufacturing code stored in the hard disk 8 and it is verified that the inserted DVD-R is authorized, the digital photo album file and the index file can be recorded onto the DVD-R by the CD/DVD reader/writer 5 according to the DVD format. The index file can be recorded in the DVD recording area as separate group as menu section to allow user to select when the digital photo album as the DVD image is ready to be played back. In certain embodiments, the original image data (i.e. raw data) (IMAGE 1, 2, 3, 5 and 6 whose formats are JPEG format and IMAGE 4 whose format is AVI format) included in the image data recording medium can be recorded from the hard disk 8 onto the DVD-R in addition to the digital photo album file and the index file by the CD/DVD reader/writer 5. After recording, the recorded DVD-R can be put out from the Photo Kiosk 1.

In this specification, the term of the image data, the still image data, the movie data, the audio data and the background music data can mean data before mixed, compressed and included in the digital photo album file or data after mixed, compressed and included in the digital photo album file, depending on the context.

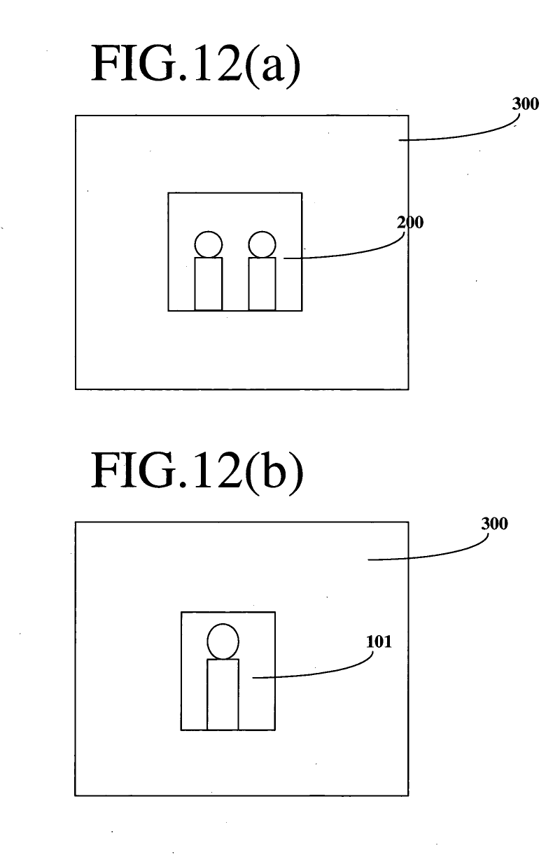

In certain embodiments, the DVD-R recording the digital photo album file and the index file can be reproduced by the DVD player. As shown in FIG. 12(a), when the DVD-R recording the digital photo album file 100 is reproduced by the DVD player connected with TV 300, the TV 300 can display the image 200 of IMAGE 2 for 20 sec. with BGM No. 3 at first. Then, as shown in FIG. 11 (b), the TV 300 can display the image 101 of IMAGE 1 for 20 sec. with BGM No. 3. After that, IMAGE 4, IMAGE6, IMAGE 2, IMAGE 1, IMAGE 4, IMAGE 6 are displayed on the TV 300 sequentially with BGM No. 3.

In certain embodiments, when the DVD-R recording the index file is reproduced by the DVD player connected with the TV 300, the user can select to display a chapter menu on the TV 200 by the controller of the DVD player. When the user selects to display the chapter menu, as shown in FIG. 13, the thumbnail image of the index file can be displayed on the TV 60. Each page of the chapter menu can include 20 thumbnails at most. If the index file includes more than 20 image data, the page of chapter menu can advance automatically. The thumbnail can have the playback linking to the chapter of the digital photo album file when user select certain thumbnail to be played from the chapter menu. The linking information can instruct the DVD player to go to the regular DVD playing mode and start from a pre-determined chapter which contains the image selected by the user. In other words, by selecting one of the thumbnail images by the controller of the DVD player, the chapter including the still image or the movie corresponding to the selected thumbnail can be started.

For instance, if the user selects the thumbnail 60 by the controller, the CHAPTER 1 including the IMAGE 1 corresponding to the thumbnail 60 can be reproduced from the beginning of the CHAPTER 1. If the user selects the thumbnail 70 by the controller, the CHAPTER 3 including the IMAGE 2 corresponding to the thumbnail 70 can be reproduced from the beginning of the CHAPTER 3.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A digital photo album producing apparatus, comprising:
a reading section which reads image data including at least one of still image data and movie data comprising audio data,
an image data storing section which stores image data read by the reading section,
a processing section which produces an index file and a digital photo album file comprising several chapters based on the image data stored in the image data storing section,
a recoding section which records the digital photo album file and the index file produced by the processing section onto a removable optical storage medium, and
wherein the digital photo album file is a serial of still image file and the index file comprises still thumbnail image data, and
wherein the processing section produces the digital photo album file by compressing and mixing the still image data and the movie data comprising the audio data into one file so that a player for the removable optical storage medium can decode and display the digital photo album file, and
wherein the processing section produces the index file so that each of the still thumbnail image data is linked with certain chapter of the digital photo album file.

2. The digital photo album producing apparatus of claim 1, wherein the processing section produces the index file so that after each page including the still thumbnail image data is displayed for a predetermined period, next page is displayed automatically.

3. The digital photo album producing apparatus of claim 1, wherein the processing section produces the index file so that each page including the still thumbnail image data is advanced to the next page manually by user's input.

4. The digital photo album producing apparatus of claim 1, wherein the removable optical storage medium is a DVD and
wherein the processing section produces the digital photo album file according to DVD video specification so that a DVD player can decode the digital photo album file, and
wherein the recoding section records the digital photo album file and the index file onto the DVD according to the DVD video specification.

5. A digital photo album producing apparatus, comprising:
means for reading image data including at least one of still image data and movie data comprising audio data,
means for storing image data read by the reading means,
means for producing a digital photo album file and an index file based on the image data stored in the storing means,
means for recording the digital photo album file and the index file produced by the producing means onto a removable optical storage medium, and
wherein the digital photo album file is a serial of still image file and the index file comprises still thumbnail image data, and
wherein the producing means produces the digital photo album file by compressing and mixing the still image data and the movie data comprising the audio data into one file so that a player for the removable optical storage medium can decode and display the digital photo album file, and
wherein the producing means produces the index file so that each of the still thumbnail image data is linked with certain part of the digital photo album file.

6. A removable data recording medium that stores instructions, which when executed by a computer perform steps in a method for representing configuration options available on a peripheral device, the steps comprising:
reading image data including at least one of still image data and movie data comprising audio data, storing image data read by the reading step,
producing a digital photo album file and an index file based on the image data stored in the storing step,
recording the digital photo album file and the index file produced by the producing step onto a removable optical storage medium, and
wherein the digital photo album file is a serial of still image file and the index file comprises still thumbnail image data, and
wherein in the producing step, the digital photo album file is produced by compressing and mixing the still image data and the movie data comprising the audio data into one file so that a player for the removable optical storage medium can decode and display the digital photo album file, and
wherein in the producing step, the index file is produced so that each of the still thumbnail image data is linked with certain part of the digital photo album file.
